(19) United States
(12) Patent Application Publication
(10) Pub. No.: US 2004/0268219 A1
(43) Pub. Date: Dec. 30, 2004

(54) Method of representing data flow between programming objects in a hierarchical display

(76) Inventors: Hans-Frederick Brown, Montreal (CA); Sylvio Drouin, Montreal (CA); Bruno Braen, Montreal (CA)

Correspondence Address: OGILVY RENAULT, 1981 MCGILL COLLEGE AVENUE, SUITE 1600, MONTREAL, QC, H3A2Y3, CA

(21) Appl. No.: 10/836,617

(22) Filed: May 3, 2004

Related U.S. Application Data
(60) Provisional application No. 60/466,791, filed on May 1, 2003.

(30) Foreign Application Priority Data
May 1, 2003 (CA) 2,427,700

(51) Int. Cl. G06F 7/00

(52) U.S. Cl. 715/500

(57) ABSTRACT

The present invention relates to a method of generating a graphical representation of a program on a display device comprising detecting hierarchical rankings of programming objects; displaying nodes representing the programming objects according to a hierarchical structure and the hierarchical rankings; detecting at least one transmission of data between a first and a second of the programming objects; and displaying on the display device a link associated to nodes representing the first and the second programming object, wherein the link represents the at least one transmission of data.

The present application claims priority of U.S. provisional application 60/466,791 filed May 1^{st}, 2003.

### BACKGROUND OF THE INVENTION

(a) Field of the Invention

The present invention relates to a graphical user interface for object-oriented programming and, more particularly, to a method of managing data flow between programming objects in a hierarchical display useful for generating, understanding, and editing data flow in object-oriented programs.

(b) Description of Prior Art

In the field of object-oriented visual programming, two different approaches have traditionally been taken. The first approach is inspired from computer file displays such as the one described in U.S. Pat. No. 5,065,347 to Pajak et al., and consists in representing programming objects as nodes of a hierarchical tree, wherein links express containment relationships. Several visual programming interfaces, such as Microsoft Visual C++, have adopted this approach due to its intuitiveness, a quality that stems from the extensive use of trees as a means of representing common data structures known to programming experts and illiterates alike, such as tables of contents. Although hierarchical trees are mostly known for their intuitiveness, they present a number of non-negligible weaknesses, one of which relates to the lack of navigational flexibility provided to users. Navigation within such trees is based on containment relationships, and a search for an element of interest is laborious when its hierarchical position is unknown. Furthermore, such structures do not represent data flows between elements, as links are limited to the expression of containment relationships. Consequently, none of data flow relationship detection, generation, and modification are supported.

The second approach is complementary to the first inasmuch as programming objects are organized on the basis of data flow relationships rather than hierarchy. It consists in representing programming objects as nodes of a graph, wherein links are dedicated to the expression of data flow relationships, thereby providing for the detection, generation and modification of such relationships. Furthermore, it provides more navigational flexibility than the former approach as nodes are allowed to have a plurality of relationships and can be accessed through any one of nodes with which they are related. In the prior art, one attempt to provide an accurate, yet flexible interface based on the very same approach is worth noting. In U.S. Pat. No. 6,051,029 to Paterson et al., a simulation model is generated by instantiating objects of interest selected from a predefined list, and instantiating links selected from a pre-defined list to represent desired relationships between the instantiated objects. As a result, users are provided with means to not only establish, but also determine the type of data flow relationships between objects. The second approach provides a remedy to several weaknesses of the first, but lacks its intuitiveness. Nodes are positioned randomly as no meaning is attributed to relative positioning. Furthermore, no information is provided with respect to hierarchical structures. Finally, navigation within such graphs is based on data flow relationships, and a search for an element of interest is laborious when its data flow relationships are unknown.

### SUMMARY OF THE INVENTION

It would be highly desirable to be provided with a method of generating a representation of data flow between programming objects in a hierarchical display.

It would also be desirable to be provided with a method of editing data flow between programming objects in a hierarchical display.

It would also be desirable to be provided with a method of accessing a programming object of interest through a combination of data flow and containment relationships in a hierarchical display.

In accordance with the present invention, there is provided a method of generating a graphical representation of a program on a display device comprising: providing a hierarchical ranking of programming objects; displaying nodes representing the programming objects according to a hierarchical structure and the hierarchical ranking; specifying at least one transmission of data between a first and a second of the programming objects; identifying parameters of the transmission according to the at least one of the first and the second programming objects; and displaying a link relating nodes representing the first and the second according to the parameters, wherein the link represents the at least one transmission of data.

In accordance with one embodiment of the present invention, the detecting at least one transmission comprises identifying one of the first and the second as a source of the transmission, and the other, as a destination of the transmission, wherein the link is displayed according to the source and the destination.

In accordance with one embodiment of the present invention, the link is displayed as a red arrow, whereby the red indicates an incoherence between a type of the source and a type of the destination.

In accordance with one embodiment of the present invention, the method further comprises requesting a detailed view of the destination, removing the link, displaying a sub-node of a node representing the destination, and displaying a new link relating the sub-node and a node representing the source in response to the requesting, wherein the sub-node represents the data.

In accordance with one embodiment of the present invention, the method further comprises requesting a non-detailed view of the destination, removing the link relating the sub-node, hiding the sub-node, and displaying a new link relating the node representing the source and the node representing the destination in response to the requesting.

In accordance with one embodiment of the present invention, the method further comprises requesting a non-detailed view, removing the link relating the first sub-node and the second sub-node, hiding the first sub-node and the second sub-node, and displaying a link associated to the node representing the source and the node representing the destination in response to the requesting.

In accordance with one embodiment of the present invention, the method further comprises displaying a label describing the transmission.

In accordance with one embodiment of the present invention, the method further comprises requesting a display of the label, wherein the label is displayed in response to the requesting.

In accordance with one embodiment of the present invention, the label indicates the source.

In accordance with one embodiment of the present invention, according to the hierarchical structure, a first node is displayed under, related through a hierarchical link to, and indented relatively to, a second node if a programming object represented by the first node is contained in a programming object represented by the second node.

In accordance with one embodiment of the present invention, the identifying comprises identifying one of at least one programming object containing the source and the destination having a lowest rank, wherein a vertical section of the link relating nodes representing the first and the second according to the parameters is aligned with a vertical section of a hierarchical link relating nodes representing the one of at least one programming object and a child of the one of at least one programming object.

In accordance with one embodiment of the present invention, the method further comprises requesting a different hierarchical structure, and modifying the graphical representation of a program according to the different hierarchical structure in response to the requesting.

In accordance with one embodiment of the present invention, the method further comprises selecting a node representing an undesirable programming object, and deleting the node representing the undesirable programming object.

In accordance with one embodiment of the present invention, the method further comprises deleting a link relating the node representing the undesirable programming object in response to the deleting the node.

In accordance with one embodiment of the present invention, the method further comprises deleting a node representing a programming object contained in the undesirable programming object in response to the deleting the node representing the undesirable programming object.

In accordance with one embodiment of the present invention, the method further comprises deleting a link relating the node representing a programming object contained in the undesirable programming object in response to the deleting a node representing a programming object contained in the undesirable programming object.

In accordance with one embodiment of the present invention, the method further comprises requesting for a node representing a programming object contained in another to be hidden, and hiding the node representing a programming object contained in another in response to the requesting.

In accordance with one embodiment of the present invention, the method further comprises requesting for each node representing a programming object contained in a selected parent programming object to be hidden, removing the each node representing a programming object contained in a selected parent programming object, removing the link, and providing a node representing the selected parent with a graphical indication of an involvement of a hidden programming object contained in the selected parent in the at least one transmission of data, wherein either one of the first and the second programming objects are contained in the selected parent.

In accordance with one embodiment of the present invention, the method further comprises requesting a detailed view of the parent, revealing nodes representing programming objects contained in the parent, removing the graphical indication associated with the node representing the selected parent, and displaying a link associated to nodes representing the first and the second programming objects.

In accordance with one embodiment of the present invention, the method further comprises requesting for a node of interest representing a programming object of interest to be displayed, searching through the hierarchical ranking for the programming object of interest, determining a rank of the programming object of interest, and displaying the node of interest according to the hierarchical rank of the programming object of interest on the display device in response to the requesting.

In accordance with one embodiment of the present invention, the method further comprises revealing at least one node representing a programming object contained in another, wherein the node of interest is one of the at least one node.

In accordance with one embodiment of the present invention, the requesting comprises selecting a link through which the node of interest is related.

In accordance with the present invention, there is provided a computer program product for generating a graphical representation of a program on a display device comprising a computer usable storage medium having computer readable program code means embodied in the medium, the computer readable program code means comprising: computer readable program code means for providing a hierarchical ranking of programming objects; computer readable program code means for displaying nodes representing the programming objects according to a hierarchical structure and the hierarchical ranking; computer readable program code means for specifying at least one transmission of data between a first and a second of the programming objects; computer readable program code means for identifying parameters of the transmission according to the at least one of the first and the second programming objects; and computer readable program code means for displaying a link relating nodes representing the first and the second according to the parameters, wherein the link represents the at least one transmission of data.

In accordance with one embodiment of the present invention, the computer readable program code means for detecting at least one transmission comprises computer readable program code means for identifying one of the first and the second as a source of the transmission, and the other, as a destination of the transmission, wherein the link is displayed according to the source and the destination.

In accordance with one embodiment of the present invention, the link is displayed as a red arrow, whereby the red indicates an incoherence between a type of the source and a type of the destination.

In accordance with one embodiment of the present invention, the computer program product further comprises computer readable program code means for requesting a detailed view of the destination, computer readable program code means for removing the link, computer readable program code means for displaying a sub-node of a node representing the destination, and computer readable program code means for displaying a new link relating the sub-node and a node representing the source in response to the requesting, wherein the sub-node represents the data.

In accordance with one embodiment of the present invention, the computer program product further comprises computer readable program code means for requesting a non-detailed view of the destination, computer readable program code means for removing the link relating the sub-node, computer readable program code means for hiding the sub-node, and computer readable program code means for displaying a new link relating the node representing the source and the node representing the destination in response to the requesting.

In accordance with one embodiment of the present invention, the computer program product further comprises computer readable program code means for requesting a non-detailed view, computer readable program code means for removing the link relating the first sub-node and the second sub-node, computer readable program code means for hiding the first sub-node and the second sub-node, and computer readable program code means for displaying a link associated to the node representing the source and the node representing the destination in response to the requesting.

In accordance with one embodiment of the present invention, the computer program product further comprises computer readable program code means for displaying a label describing the transmission.

In accordance with one embodiment of the present invention, the computer program product further comprises computer readable program code means for requesting a display of the label, wherein the label is displayed in response to the requesting.

In accordance with one embodiment of the present invention, the label indicates the source.

In accordance with one embodiment of the present invention, according to the hierarchical structure, a first node is displayed under, related through a hierarchical link to, and indented relatively to, a second node if a programming object represented by the first node is contained in a programming object represented by the second node.

In accordance with one embodiment of the present invention, the computer readable program code means for identifying comprises computer readable program code means for identifying one of at least one programming object containing the source and the destination having a lowest rank, wherein a vertical section of the link relating nodes representing the first and the second according to the parameters is aligned with a vertical section of a hierarchical link relating nodes representing the one of at least one programming object and a child of the one of at least one programming object.

In accordance with one embodiment of the present invention, the computer program product further comprises computer readable program code means for requesting a different hierarchical structure, and computer readable program code means for modifying the graphical representation of a program according to the different hierarchical structure in response to the requesting.

In accordance with one embodiment of the present invention, the computer program product further comprises computer readable program code means for selecting a node representing an undesirable programming object, and computer readable program code means for deleting the node representing the undesirable programming object.

In accordance with one embodiment of the present invention, the computer program product further comprises computer readable program code means for deleting a link relating the node representing the undesirable programming object in response to the deleting the node.

In accordance with one embodiment of the present invention, the computer program product further comprises computer readable program code means for deleting a node representing a programming object contained in the undesirable programming object in response to the deleting the node representing the undesirable programming object.

In accordance with one embodiment of the present invention, the computer program product further comprises computer readable program code means for deleting a link relating the node representing a programming object contained in the undesirable programming object in response to the deleting a node representing a programming object contained in the undesirable programming object.

In accordance with one embodiment of the present invention, the computer program product further comprises computer readable program code means for requesting for a node representing a programming object contained in another to be hidden, and computer readable program code means for hiding the node representing a programming object contained in another in response to the requesting.

In accordance with one embodiment of the present invention, the computer program product further comprises (computer readable program code means for requesting for each node representing a programming object contained in a selected parent programming object to be hidden, computer readable program code means for removing the each node representing a programming object contained in a selected parent programming object, computer readable program code means for removing the link, and computer readable program code means for providing a node representing the selected parent with a graphical indication of an involvement of a hidden programming object contained in the selected parent in the at least one transmission of data, wherein either one of the first and the second programming objects are contained in the selected parent.

In accordance with one embodiment of the present invention, the computer program product further comprises computer readable program code means for requesting a detailed view of the parent, computer readable program code means for revealing nodes representing programming objects contained in the parent, computer readable program code means for removing the graphical indication associated with the node representing the selected parent, and computer readable program code means for displaying a link associated to nodes representing the first and the second programming objects.

In accordance with one embodiment of the present invention, the computer program product further comprises computer readable program code means for requesting for a node of interest representing a programming object of interest to be displayed, computer readable program code means for searching through the hierarchical ranking for the programming object of interest, computer readable program code means for determining a rank of the programming object of interest, and computer readable program code means for displaying the node of interest according to the hierarchical rank of the programming object of interest on the display device in response to the requesting.

In accordance with one embodiment of the present invention, the computer program product further comprises computer readable program code means for revealing at least one node representing a programming object contained in another, wherein the node of interest is one of the at least one node.

In accordance with one embodiment of the present invention, the computer readable program code means for requesting comprises computer readable program code means for selecting a link through which the node of interest is related.

### BRIEF DESCRIPTION OF THE DRAWINGS

FIG. 1 illustrates a block diagram of a computer system within which software for performing the methods of the present invention, may reside and be executed;

FIG. 2 illustrates exemplary representations of programming elements;

FIG. 3 illustrates an exemplary node-link structure of a program created according to the methods of the present invention;

FIG. 4 illustrates an application window comprising a pane presenting a view of the structure;

FIG. 5 illustrates the application window comprising a pane presenting the view of the structure as it is being created, wherein a node is being added to the structure according to the methods of the present invention;

FIG. 6 illustrates the application window comprising the pane presenting the view of the structure as it is being created, wherein the added node is assigned a name;

FIG. 7 illustrates the application window comprising the pane presenting the view of the structure as it is being created, wherein a source of a link to be added is specified;

FIG. 8 illustrates the application window comprising the pane presenting the view of the structure as it is being created, wherein the destination of the link is specified;

FIG. 9 illustrates the application window comprising the pane presenting the view of the structure, wherein a source of a second link to be added is specified;

FIG. 10 illustrates the application window comprising the pane presenting the view of the structure, wherein a destination of the second link is specified;

FIG. 11 illustrates the application window comprising the pane presenting the view of the structure, wherein a node is being deleted;

FIG. 12 illustrates the application window comprising the pane presenting the view of the structure, wherein the node is deleted;

FIG. 13 illustrates the application window comprising the pane presenting the view of the structure, wherein a link to be removed is specified;

FIG. 14 illustrates the application window comprising the pane presenting the view of the structure, wherein the specified link is removed;

FIG. 15 illustrates the application window comprising the pane presenting the view of the structure, wherein a parent node to be collapsed is specified;

FIG. 16 illustrates the application window comprising the pane presenting the view of the structure, wherein the parent node is collapsed; and

FIG. 17 illustrates the application window comprising the pane presenting the view of the structure, wherein a tool tip presenting information relating to a data flow represented by a specified link is displayed.

### DETAILED DESCRIPTION OF THE INVENTION

In accordance with the present invention, there is provided a method of managing data flow between programming objects in a hierarchical display, for generating, understanding, and editing data flow in object-oriented programs. Those skilled in the art will readily appreciate that systems and methods according to the present invention can be applied to any type of display system having a programming interface.

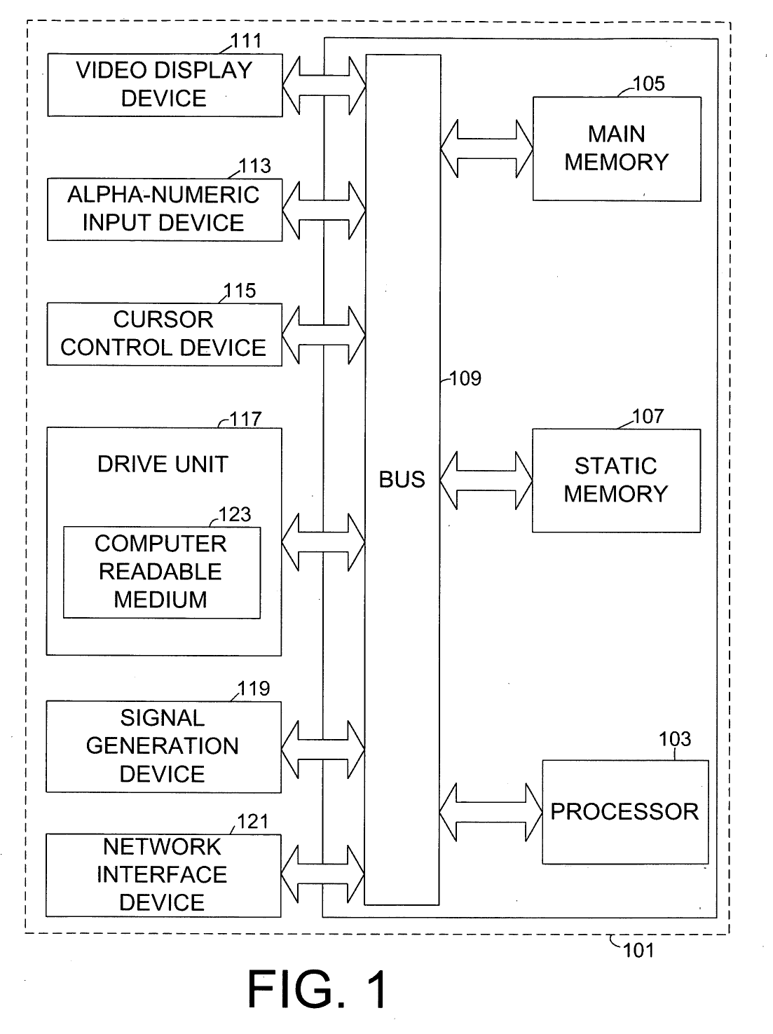

FIG. 1 illustrates a block diagram of a computer system 101 within which software for performing methodologies discussed below, and for generating a graphical user interface (GUI) according to teachings of the present invention, may operate. The computer system 101 includes a processor 103, a main memory 105 and a static memory 107, which communicate via a bus 109. This system 101 is further shown to include a video display device 111, such as a liquid crystal display (LCD) or a cathode ray tube (CRT), on which a GUI, according to the present invention, may be displayed. The computer system 101 also includes an alphanumeric input device 113, such as a keyboard, a cursor control device 115, such as a mouse, a disk drive unit 117, a signal generation device 119, such as a speaker, and a network interface device 121.

In the preferred embodiment, the static memory 107 comprises classes of objects, which may be coded using an object-oriented language such as C++ or Java. As is well known within the art, each object may comprise a collection of parameters, also commonly referred to as instances, variables or fields, and a collection of methods, which utilize the parameters of the relevant object. Furthermore, objects vary in terms of their complexity: the most primitive ones may implement simple concepts such as integer values, arithmetic operations, or flags, while others may be dedicated to the intricacies of a dynamic character in the context of a computer game. It is important to note that considerable levels of complexity and abstractness may be attained by combining complementary objects and defining their relationships. The functioning and purposes of each of the various classes of objects will become apparent from the description that follows. The memory 107 also comprises a library of icons, wherein each icon is associated with an object or a type of relationship thereof, and may be displayed within a diagram window presented by a Graphical User Interface (GUI). In the following description, the term “node” shall be interpreted as an icon associated with an object, the term “sub-node”, as an icon associated with a combination of one input parameter and one output parameter involved in a same data flow, and the term “link”, as an icon associated with a type of relationship.

In the preferred embodiment, the main memory 105 comprises a software application for executing instructions received from a user through the alphanumeric input device 113 and the cursor control device 115. It also comprises the user's current workspace, which represents a combination of instantiated objects and relationships, as well as the coordinates of corresponding nodes and links displayed on the GUI.

In another embodiment, the content of the memory 105 and 107 may very well reside in a computer-readable medium 123 accessible via the disk drive unit 117, or the network interface device 121. The term “computer-readable medium” shall be taken to include any medium which is capable of storing or encoding a sequence of instructions for performing the methodologies of the present invention, and shall be taken to include, but not be limited to, optical and magnetic disks, and carrier wave signals.

The present invention allows a person with any level of programming knowledge to easily create a representation of a program by instantiating objects extracted from a library, and defining their relationships. However, prior to unskilled user interaction with the GUI, objects must be implemented and stored, according to the preferred embodiment, in the static memory 107. As mentioned above, objects may be implemented using any object-oriented programming language such as C++ or Java. Furthermore, the graphical representation of objects and relationships must be designed and stored in the memory 107.

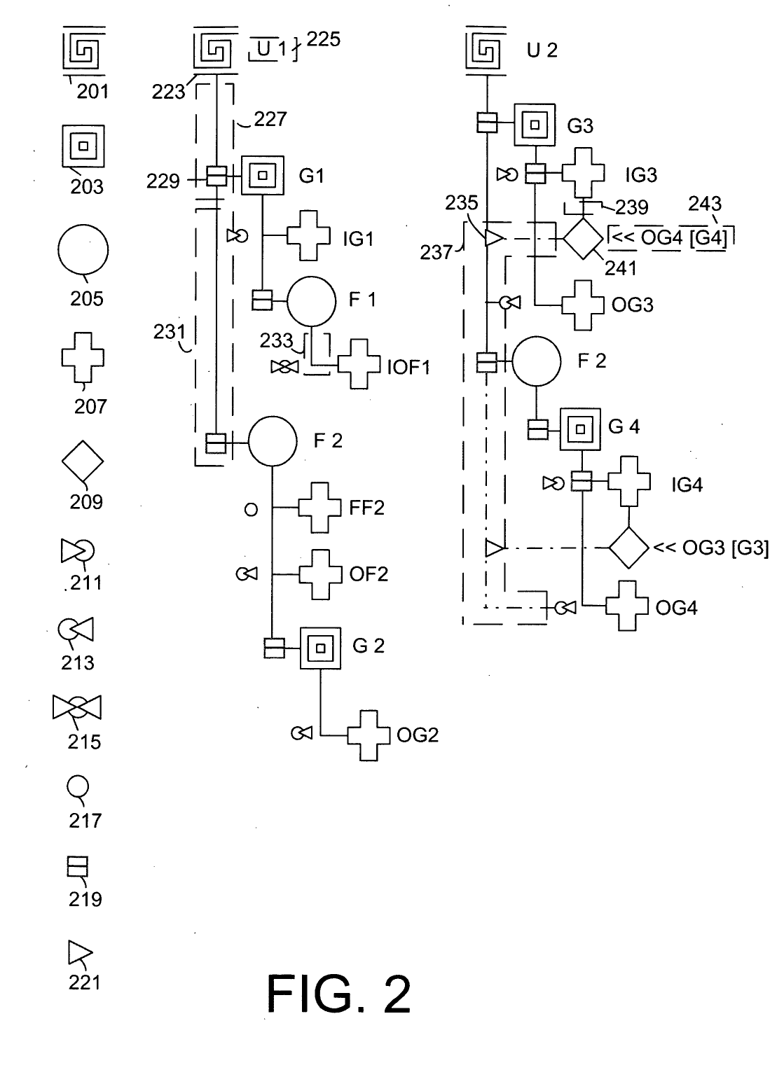

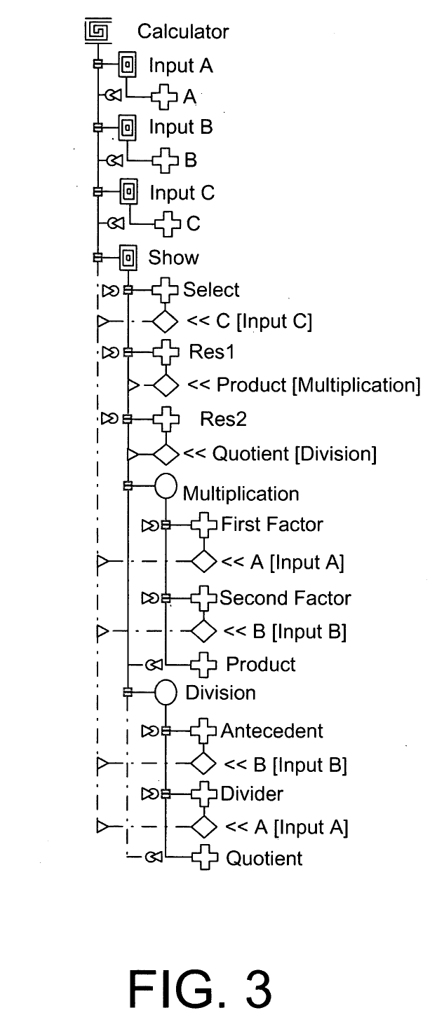

FIG. 2 provides examples of graphical elements, which according to one exemplary embodiment of the invention, are provided by a GUI, and may be utilized to create a visual representation of a program such as that shown in FIG. 3. It will be appreciated that the graphical elements discussed below are exemplary and any distinctive graphical element may be substituted for the graphical elements discussed below without departing from the spirit of the invention. Furthermore, a labeled node shall be taken to designate an underlying object.

Referring now to FIG. 2, there are illustrated three types of nodes available to the user, each of which represents a specific type of object. Each node is assigned a label identifying an underlying object and, in the preferred embodiment, each node is displayed to the left of a corresponding node. For instance, a label 225 is assigned to a node 223 indicating that an object underlying the node 223 is identified as “U1”. In another embodiment, labels are displayed within corresponding nodes. All nodes comprise a list.

A node 201 represents a universal object. The latter are the highest ranked objects in a hierarchical structure. In other words, they are the only objects that are not contained within others. They comprise a list of pointers referring to all nodes situated in an immediate lower level. In the preferred embodiment, each program comprises at least one universal node. Furthermore, a universal object bears the name of, and is used as a reference point to, a program modeled by its offspring nodes. In an example illustrated in FIG. 2, the node U1 represents a universal object.

A node 203 represents a gate object. The latter are of two types, namely input and output gate objects. The input gate objects comprise a method which, when executed, retrieves data from a specific input device such as the alphanumeric input device 113, and the cursor control device 115, and provides it to another node. Conversely, the output gate objects comprise a method which, when executed, retrieves data from another node, and provides it to a specific output device, such as the display device 111 or the signal generation device 119. As such, gate objects provide means for a user-generated program to access the external resources of the system 101. In an example illustrated in FIG. 2, a node labeled “G1” represents an input gate while another labeled “G2” represents an output gate.

A node 205 represents a functional object. The latter comprises parameters as well as methods describing functions that may be applied on the parameters. In an example illustrated in FIG. 2, a node labeled “F1” represents a functional object.

A node 207 represents a port. The latter comprises one parameter defined by a type and a value. The term “type” shall be taken to include, but not be restricted to, integer, float, double, character, and string.

A sub-node 209 distinguishes itself from the nodes 201, 203, and 205, as it does not represent an object. The node 209 is displayed under a port involved at a receiving end of a data flow, and represents a value to be assigned to the port through the execution of the data flow. Its label identifies a port in which the value is stored prior to an execution of the data flow. In an example illustrated in FIG. 2, a sub-node 241 is displayed under a node labeled “IG2”, and represents a value to be assigned to the port IG2 following an execution of a data flow. A label 243 displayed as adjacent to the node 241 identifies a source of the data flow as a port labeled OG4, pertaining to an object labeled “G4”.

Data flow reference points 277, 279, 281, and 283 represent visual indicators through which users may create data flows involving a corresponding port. The reference point 277 indicates that a corresponding port may only receive data, and as such, may only be considered as a data flow destination. The reference point 279 indicates that a corresponding port may only send data, and as such, may only be considered as a data flow source. As for the reference point 281, it indicates that a corresponding port may send and/or receive data, and as such, may be considered as a data flow source and/or destination. Finally, the reference point 283 indicates that a corresponding port may neither send nor receive data, and as such, may be neither a source nor a destination of a data flow. In an example illustrated in FIG. 2, the port IG1 may only receive data, the port OG2 may only send data, a port labeled “IOF1” may send and receive data, whereas a port labeled FF2 may neither send nor receive data.

Still referring to FIG. 2, there are illustrated three types of links, each of which is associated with a specific type of relationship. Hierarchical links 227 and 231 represent containment relationships according to which the objects G1 and F2 are contained in the object U1. Similarly, a link 233 represents a containment relationship according to which the port IOF1 is contained in the object G1. An expansion indicator 229, is displayed on containment relationships as adjacent to nodes representing objects that have at least one child, as well as those that are associated to at least one sub-node, whereby users may collapse or expand a node-link structure originating from a corresponding node.

An object contained in another is deemed dependent upon the latter, and therefore, in the preferred embodiment, when one of a set of actions comprising at least the deletion of a node applied to a container, it is also applied to objects contained therein. In an example illustrated in FIG. 2, the objects F1 and IG1 are connected to the object G1, and the object IOF1 is connected to the object F1 through links expressing containment relationships, wherein the objects F1 and IG1 are contained in the object G1, and the object IOF1 is contained in the object F1. Therefore, if the node G1 were to be deleted, the nodes F1, IOF1, and IG1 would be deleted as well.

A data flow link 237 represents a data flow relationship between the objects G3 and G4. More specifically, it represents a data flow which, once executed, assigns a value stored in the port OG4, pertaining to the object G4, to the port IG3, pertaining to the object G3. In the preferred embodiment, objects are implemented according to a “pull mechanism”, and the object G4 comprises a method which, when executed, pulls data stored in the port OG3 of the object G3, and stores them in its port IG4. In another embodiment, objects are implemented according to a “push mechanism”, and the object G3 pushes data stored in its port OG3 to the object G4 in order to have it stored in the port IG4.

In one embodiment, the objects OG3 and IG4 are of the same type. However, in the preferred embodiment, they may be of a different type, in which case, the object G4 comprises yet another method which, when executed, converts data received from the object G3 according to a type of the port IG4. In the embodiment wherein objects are coded according to a “push mechanism”, G3 comprises another method which, when executed, converts data stored in the port OG3 according to the type of the port IG4.

It is important to note that containment and data flow links may overlap, as shown in FIG. 2, where a containment link associating the objects U2 and F2 overlaps the data flow link 229. In one embodiment, graphical indicators, such as a triangle 221 are displayed along data flow links in order to clearly specify their orientation. In the preferred embodiment, the triangle 221 is displayed at the intersection of a vertical section and a horizontal section of a corresponding data flow link, at the level of, and pointing towards, a corresponding sub-node. In an example illustrated in FIG. 2, a triangle 235 is displayed at the intersection of a horizontal section and a vertical section of the data flow link 235, pointing towards the sub-node 241.

A sub-link 239 may be interpreted as a continuation of a data flow link, as it associates a sub-node to a corresponding port node. More specifically, it associates the sub-node 241 to the port node IG3′, indicating that a value represented by the node 241 is assigned to the port IG3 as a result of an execution of the data flow represented by the data flow link 237.

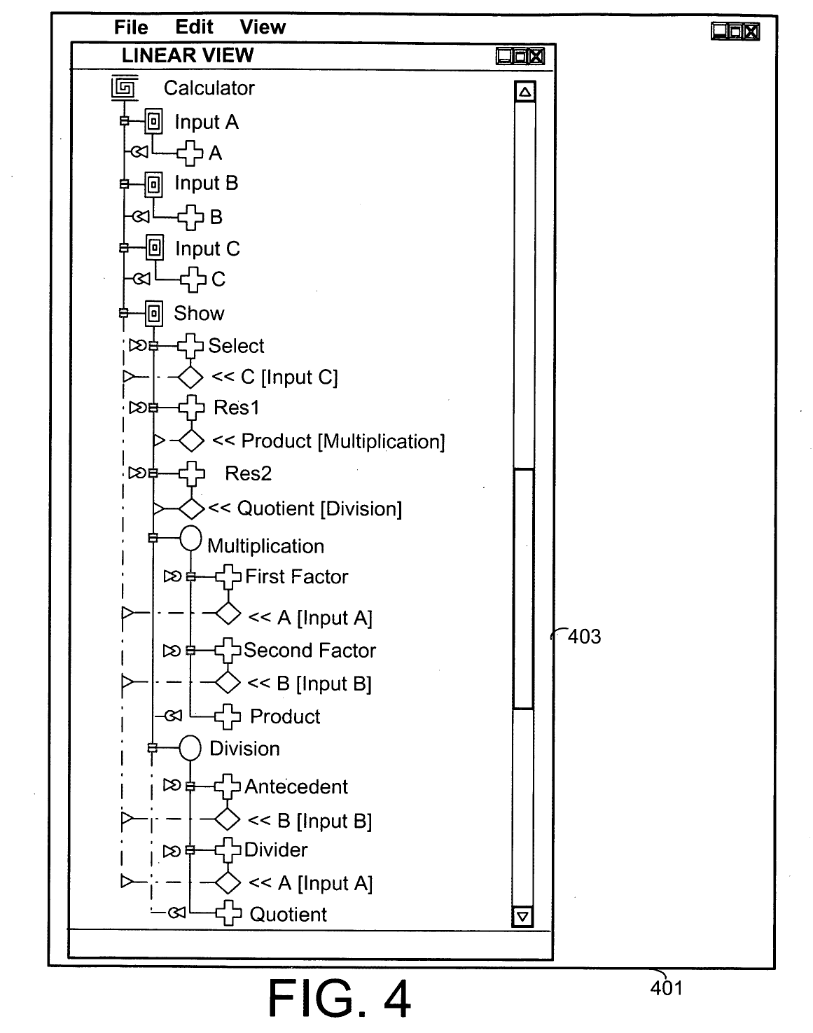

The following description refers tc) a method of generating the representation illustrated in FIG. 3 using the nodes and links described herein above and provided by a GUI illustrated in FIG. 4. The program consists of a calculator capable of multiplying and dividing two numbers given by a user through the input device 113, and providing a result to the display device 111. When a user requests for an object labeled Calculator to be executed, objects labeled “Input A” and “Input B” retrieve integers provided through an input device 113, and store them in ports labeled “A” and “13” respectively. An object labeled “Input C” retrieves a character and stores it in a port labeled “C”. An object labeled “Multiplication” retrieves integers stored in ports A and B, and stores them in ports labeled “First Factor” and “Second Factor” respectively. Subsequently, it multiplies the integer stored in the port First Factor by the integer stored in the port Second Factor, and stores the result in a third port labeled “Product”. An object labeled “Division” retrieves integers stored in ports A and B, and stores them in ports labeled “Antecedent” and “Divider” respectively. Subsequently, it divides the integer stored in the port Antecedent by the one stored in the port Divider, and stores the result in a third port labeled “Quotient”. An object labeled “Show” retrieves the integers stored in the ports Product, Quotient, as well as the character stored in the port C, and stores them in ports labeled “Res1”, “Res2”, and “Select”, respectively. Finally, the object Show outputs one of the integers stored in its ports Res1 and Res2 to the video display device 111 according to the character stored in its port Select.

FIG. 4 illustrates an application window 401 comprising a pane 403 presenting a view of the node-link structure representing the program. The user may create the entire structure within the pane 403, without requiring for other panes to be displayed. However, since hierarchical node-link structures expand along a vertical axis and require a negligible amount of horizontal space, other panes may be displayed within the window 401, in combination with the pane 403, in order to provide complementary information.

According to the present invention, the node-link structure is saved in memory, wherein each node is assigned a name, a type, a status regarding whether it is revealed or hidden, a list of pointers to its children, a pointer to its parent, as well as a list of nodes with which it entertains data flow relationships. The saved structure is updated at the occurrence of every relevant event in order for the interface to be practical. The term “relevant event” shall be taken to include, but not be limited to, a creation of a node, a creation of a link, a deletion of node, a deletion of a link, a collapse of a node, an expansion of a node, as well as a modification of a label.

In order to achieve such a display, the user must previously request for a view of a blank structure to be presented within the pane 403. A blank view is comprised of a universal, unlabelled, node. In the preferred embodiment, the user assigns to the universal node a name that clearly identifies the program to be created. In the case of FIG. 4, the universal node is labelled “Calculator”, as the program will be designed to receive two numbers, calculate their product as well as their quotient, and display either one of the latter according to the user's request.

Once the universal node is labelled, the user adds nodes to the blank structure in order to establish a hierarchical structure of the program. Prior to adding a node, the user is required to identify its hierarchical ranking therein. More specifically, he is required to identify its parent. If the parent has not yet been added to the structure, the user is required to do so in order to set up the addition of its child. However, if the parent has already been created, the user may proceed with the addition of the child by selecting the parent through a mouse pointer, and clicking on the right button of the mouse in order for a corresponding menu to be displayed. Subsequently, the user selects a “Create Child” entry from the menu in order for a second menu, comprising a library of objects, to be displayed as adjacent to the first. The user may browse through the second menu to specify a type of the object to be added.

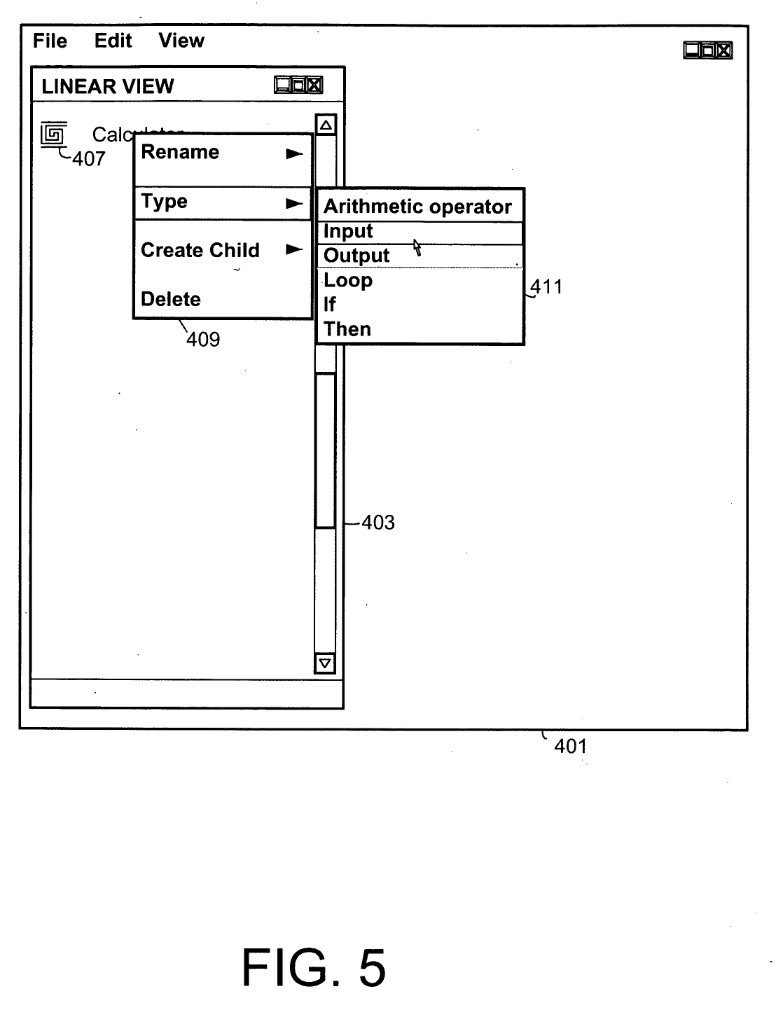

FIG. 5 illustrates the window 401, comprising a pane 403 presenting the view of the structure as it is being created, wherein a node is being added to the structure according to the methods of the present invention.

In order to add a node to the structure, the user verifies whether its parent, the Calculator, has already been created. Since a node 407 representing the Calculator is comprised within the view of the structure presented by the pane 403, the user may create a child thereof. Consequently, he selects the Calculator through the mouse pointer and clicks on the right-button in order to display a first menu 409. He then selects the “Create Child” entry from the menu 409, and a second menu 411 is displayed as adjacent to the first one. From the second menu, the user selects an “Input” entry from the menu, since he would like to add a node responsible for retrieving an operand from the input device 113.

Once the user specifies the type of the object to be added, a corresponding node is retrieved from the memory 105, and displayed within the pane 403, as indented relatively to a position of its parent. To clearly indicate the hierarchical relation between the parent and his child, a hierarchical link is displayed between the two corresponding nodes. In the preferred embodiment, a label box comprising a blinking cursor is displayed as associated to the newly added child, in order for the user to enter its name. However, in other embodiments, the label box is displayed in response to a request issued by the user following the addition of the node to the structure.

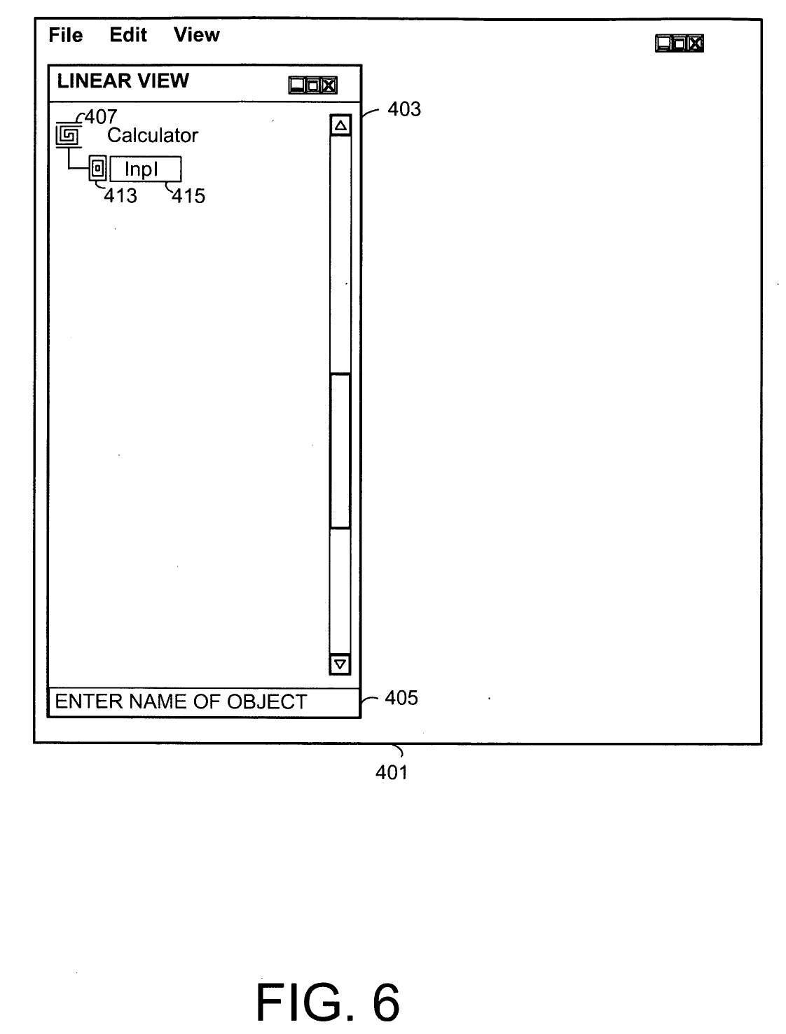

FIG. 6 illustrates the application window 401 comprising the pane 403 presenting the view of the structure as it is being created, wherein the added node 413 is assigned a name.

As previously mentioned, the user identified the type of the new object as being “Input”. Since an object of the latter type corresponds to a gate, a representation of the node 203 is retrieved from the memory 105, and displayed within the pane 403 as a node 413. The latter is indented relatively to the node 407, its parent. To clearly indicate their hierarchical relationship, a link is displayed between the nodes 407 and 409. Furthermore, a tool tip 405 displayed at the bottom of the pane 403, instructs the user to assign a name to the node 413 in a label box 415 associated thereto.

In the preferred embodiment, the user iterates through the process described herein above until all nodes of the program have been defined. At that point, the hierarchical structure of the program is established. According to the present invention, the data flow of the program may be incorporated within its hierarchical structure. In order to do so, the user is required to specify a source, and a destination of each data flow to be added, as well as variables involved therein.

In order to add a data flow, the user must first identify its source. In the preferred embodiment, this is done by selecting, through the mouse pointer, a corresponding data flow reference point displayed within the pane 403 as associated to a node representing the source.

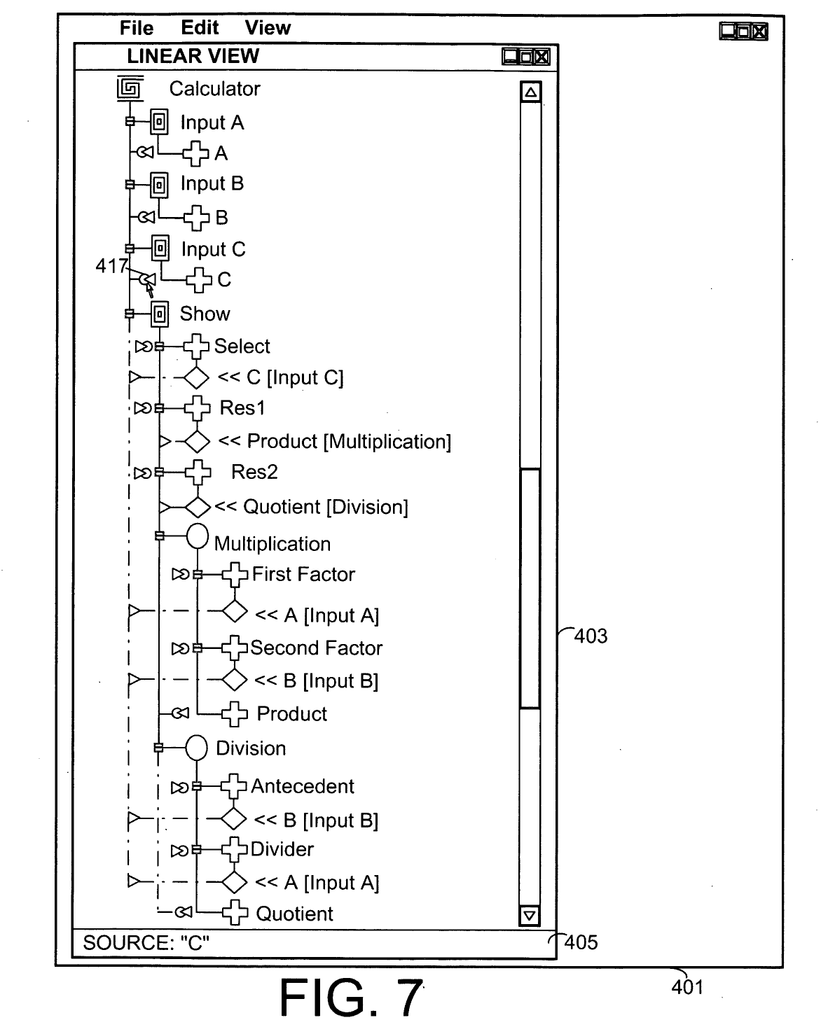

FIG. 7 illustrates the application window 401 comprising the pane 403 presenting the view of the structure as it is being created, wherein a source of a link to be added is specified.

The user wants to add a link to the structure of the program, wherein a source of the data flow is the port C, pertaining to the object Input C. Consequently, he moves the mouse pointer to a data flow reference point 417 displayed as associated to the node 415, and clicks on the left button of the mouse. Subsequently, the tool tip 405 displays a message confirming that the port C has been identified as the source of a link to be added.

In the preferred embodiment, the process of identifying a destination of a data flow is identical to that of identifying its source, but occurs after the latter. More specifically, the user is required to select, through the mouse pointer, a data flow reference point displayed within the pane 403 as associated to a node representing the destination port. Subsequently, the tool tip 405 displays a message confirming the identified destination.

Once the destination is selected, a sub-node is displayed as associated to the corresponding node through a sub-link, and a label specifying the source port of the data flow is displayed as adjacent to the sub-node. Subsequently, the node-link structure is traversed from the two nodes in search of their closest common ancestor. Once a common ancestor is found, a data flow link is displayed between a data flow reference of a source node and the sub-node, where a vertical section of the data flow link is aligned with that of a hierarchical link associating their common ancestor to its at least one immediate child.

Such a representation of data flows within a hierarchical display is very practical as an amount of horizontal space occupied by the pane 403 within the window 401 is maintained, thereby avoiding its expansion at the expense of other panes displayed therein.

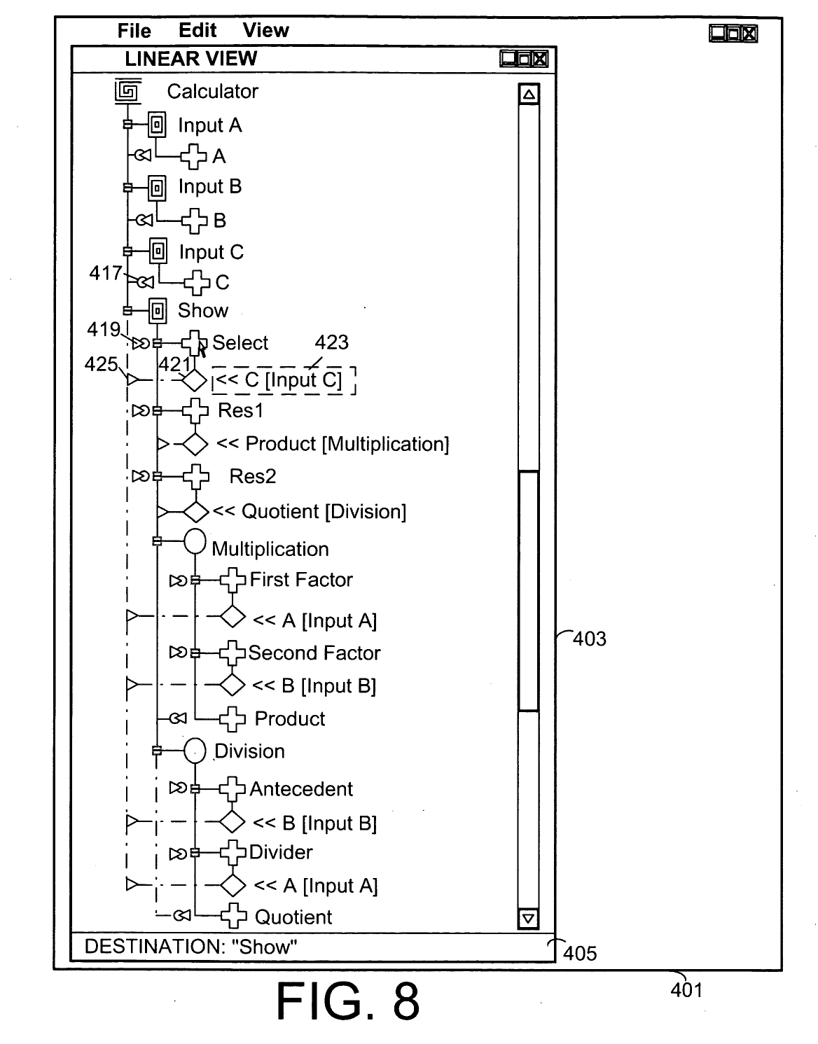

FIG. 8 illustrates the application window 401 comprising the pane 403 presenting the view of the structure as it is being created, wherein the destination of the data flow is specified.

The user wishes to identify the port Select as the destination of the data flow to be added. Consequently, he moves the mouse pointer over a reference point 419 displayed as associated to the node Select, and clicks on the left button of the mouse. In response to the selection, the tool tip 405 displays a message confirming that the node 419 has been identified as the destination of the data flow to be added, a sub-node 421 is displayed as associated to the node Select through a sub-link, and a label 423 specifying the source of the data flow as the port C is displayed as adjacent to the sub-node 421.

Subsequently, the node-link structure is traversed from the nodes C and Select to locate their common ancestor, namely the node Calculator. As a result, a data flow link is displayed between the data reference point 417 and the sub-node 421, where the vertical section of the data flow link is aligned with the vertical section of a hierarchical link associating the node Calculator to an immediate child, such as the nodes Input A, Input B, or Input C.

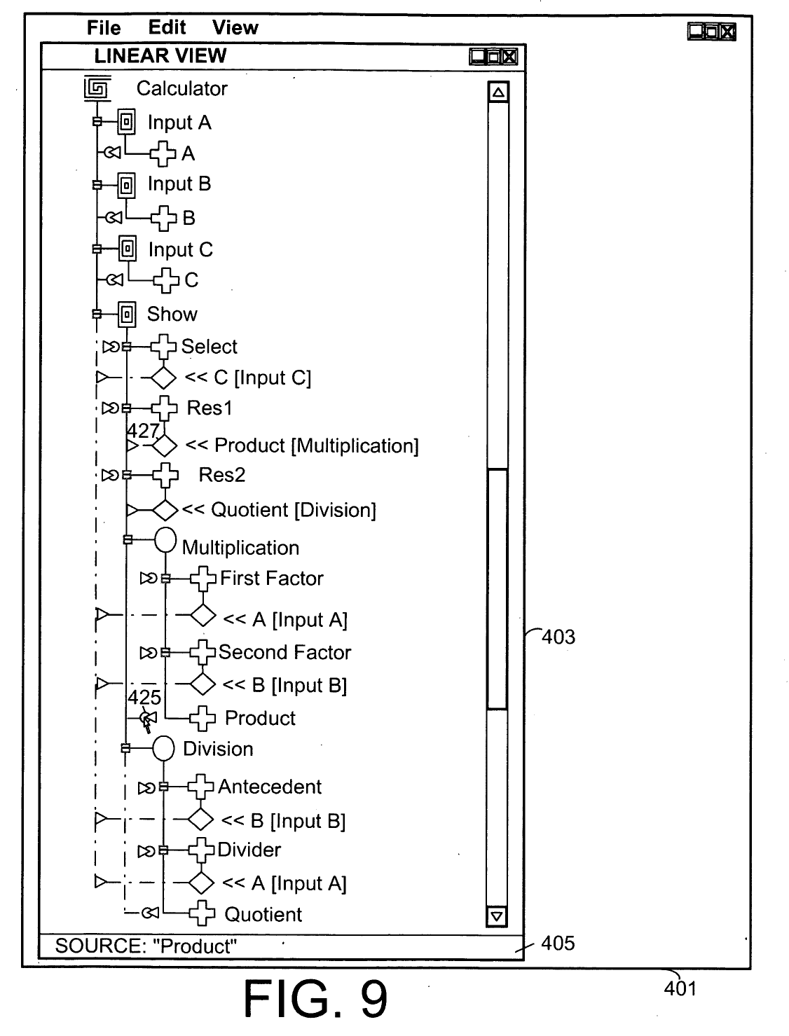

FIG. 9 illustrates the application window 401 comprising the pane 403 presenting the view of the structure, wherein a source of a second link to be added is specified.

The user wishes to add a link to the structure of the program, wherein a source of the data flow is the port Product. Consequently, he moves the mouse pointer to a reference point 425 displayed as associated to the port Product, and clicks on the left button of the mouse, in response to which the tool tip 405 displays a message confirming that the port Product has been identified as the source of a data flow to be added, and prompting the user to identify the destination of the latter.

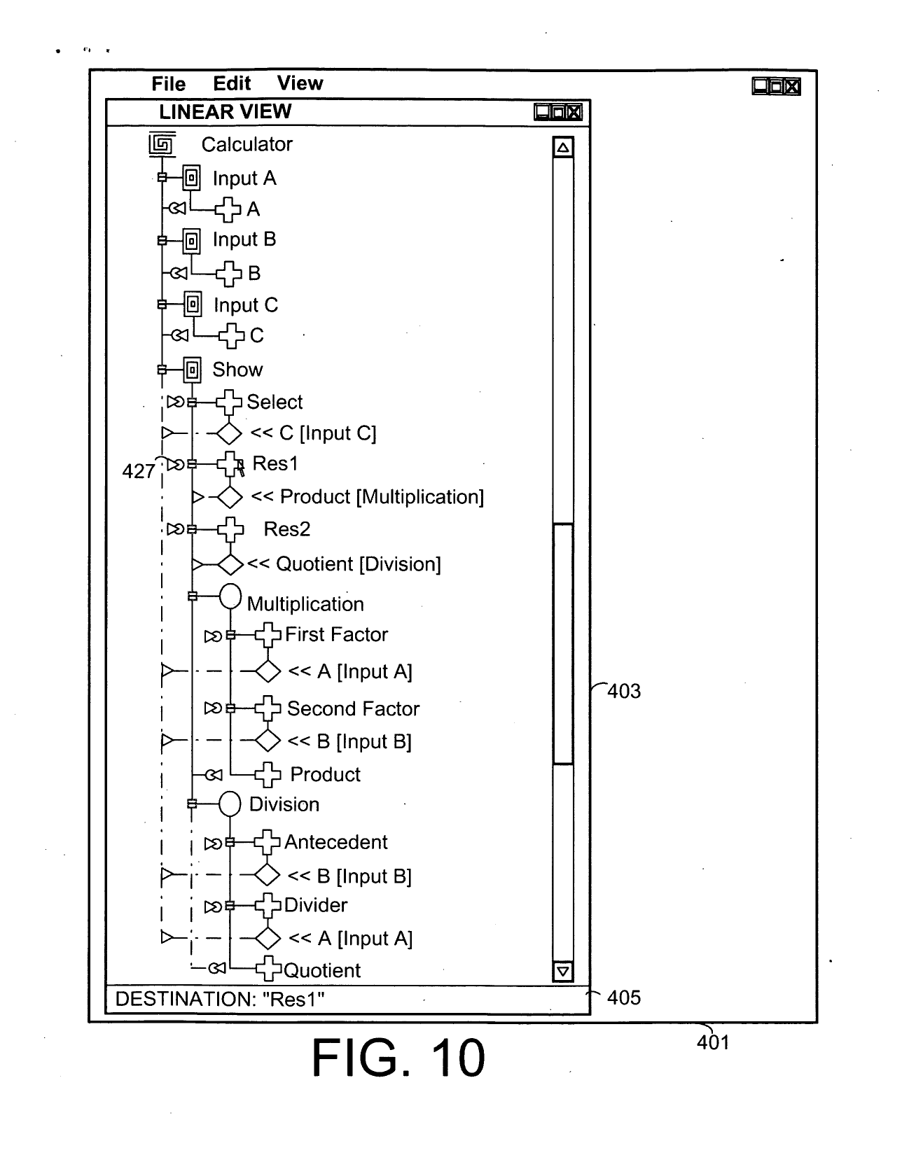

FIG. 10 illustrates the application window 401 comprising the pane 403 presenting the view of the structure, wherein a destination of the second data flow is specified, and a rank of the destination is, different from that of the source.

The user wishes to identify the port Res1 as the destination of the second data flow to be added. Consequently, he moves the mouse pointer over a reference point 427 displayed as associated to the node Res1, and clicks on the left button of the mouse, in response to which the tool tip 405 displays a message confirming that the node 419 has been identified as the destination of the data flow to be added. Furthermore, a sub-node 421 is displayed as associated to the node Select through a sub-link, and a label 423 specifying the source of the data flow as the port C is displayed as adjacent to the sub-node 421.

Subsequently, the node-link structure is traversed from the nodes Product and Res1 to locate their common ancestor, namely the node Show. As a result, a data flow link is displayed between the data reference point 425 and the sub-node 427, where the vertical section of the data flow link is aligned with the vertical section of a hierarchical link associating the node Show to an immediate child, such as the node Select.

During the process of creating a structure of a program, users often require that a created node be deleted. According to the present invention, in order to delete a node from the structure of the program a user moves the mouse pointer to its location within the pane 403, clicks on the right button of the mouse in order to display the menu 409, and selects a “Delete” entry from the menu 409, in response to which, the node, its reference point, as well as an eventual expansion indicator and hierarchical link through which it is related to its parent are removed from the view presented by the pane 403.

According to a preferred embodiment of the invention, if the deleted node has children, the latter are automatically removed from the view presented by the pane 403. Furthermore, if it is involved in a data flow, all corresponding nodes and links are removed as well.

In another embodiment, the children maintain their position, and are highlighted in order to indicate their lack of a parent. The user may choose to delete them or assign to them a new parent.

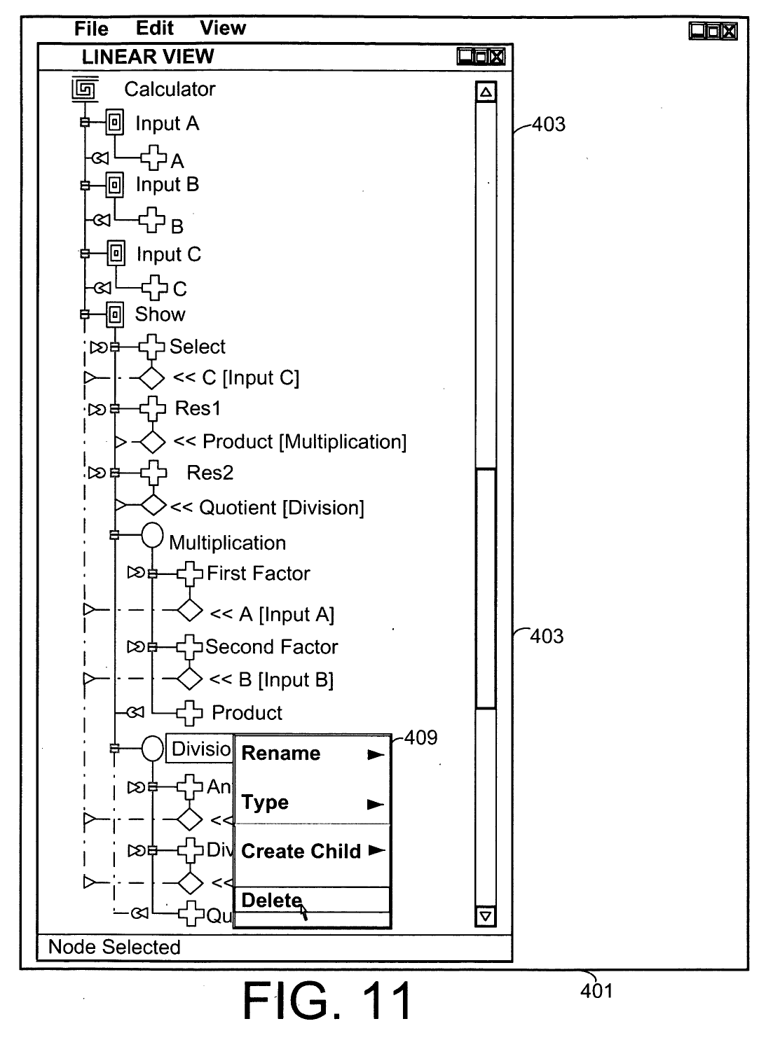

FIG. 11 illustrates the application window 401 comprising the pane 403 presenting the view of the structure, wherein a node 435 is being deleted.

The user wishes to delete the object Division from the structure of the program. Consequently, he moves the mouse pointer to a location of the node Division, and clicks on the right button of the mouse in order to display the menu 409. He then selects the “Delete” entry from the menu 409, in response to which, the node Division, its expansion indicator and a hierarchical link through which it is related to the node Show are deleted.

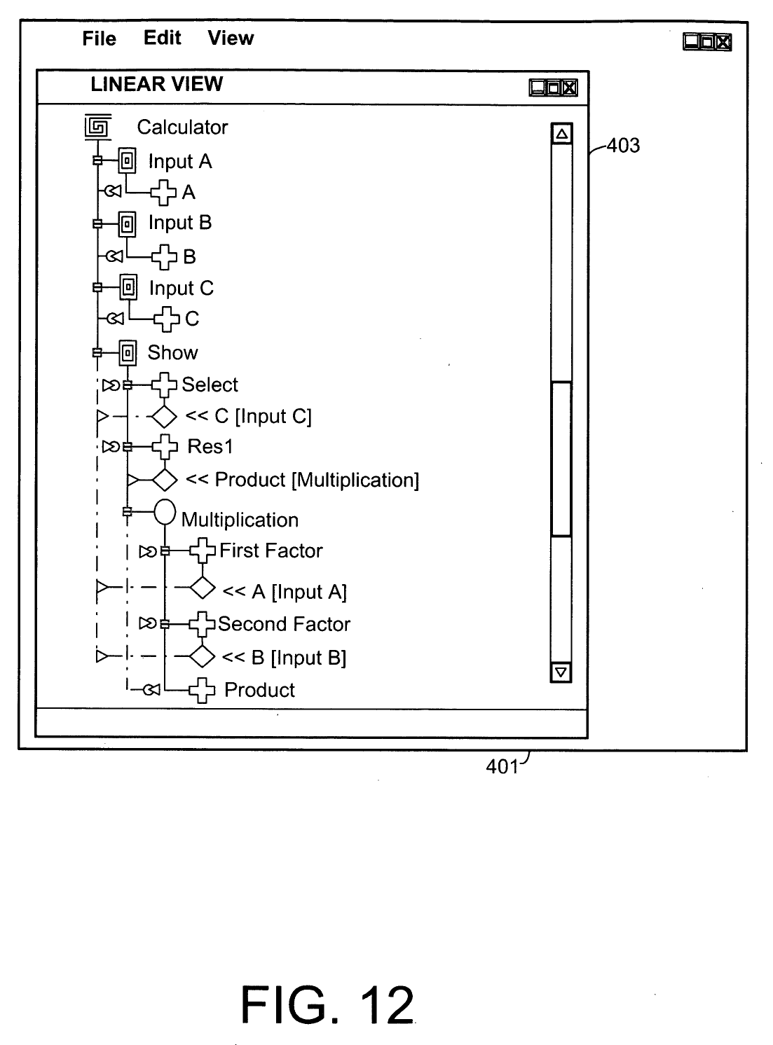

The node Show has three children, namely the ports Antecedent, Divider, Quotient, each of which is involved in a data flow. Consequently, all icons representing its children and their data flows are removed. The resulting node-link structure of the program is illustrated in FIG. 12.

Users may also require that a created data flow link be deleted. According to a preferred embodiment of the present invention, in order to delete such a link from the structure of the program, a user moves the mouse pointer to its location within the pane 403, clicks on the left button of the mouse in order to select it, and clicks on a control button responsible for deleting selected elements, in response to which, the link and sub-nodes to which its is associated are removed from the structure.

In another embodiment, a user deletes a link by moving the mouse pointer over its location within the pane 403, clicking on the right button of the mouse in order to display a menu, and selecting a “Delete” entry from the displayed menu, in response to which the link and associated sub-nodes are removed from the structure.

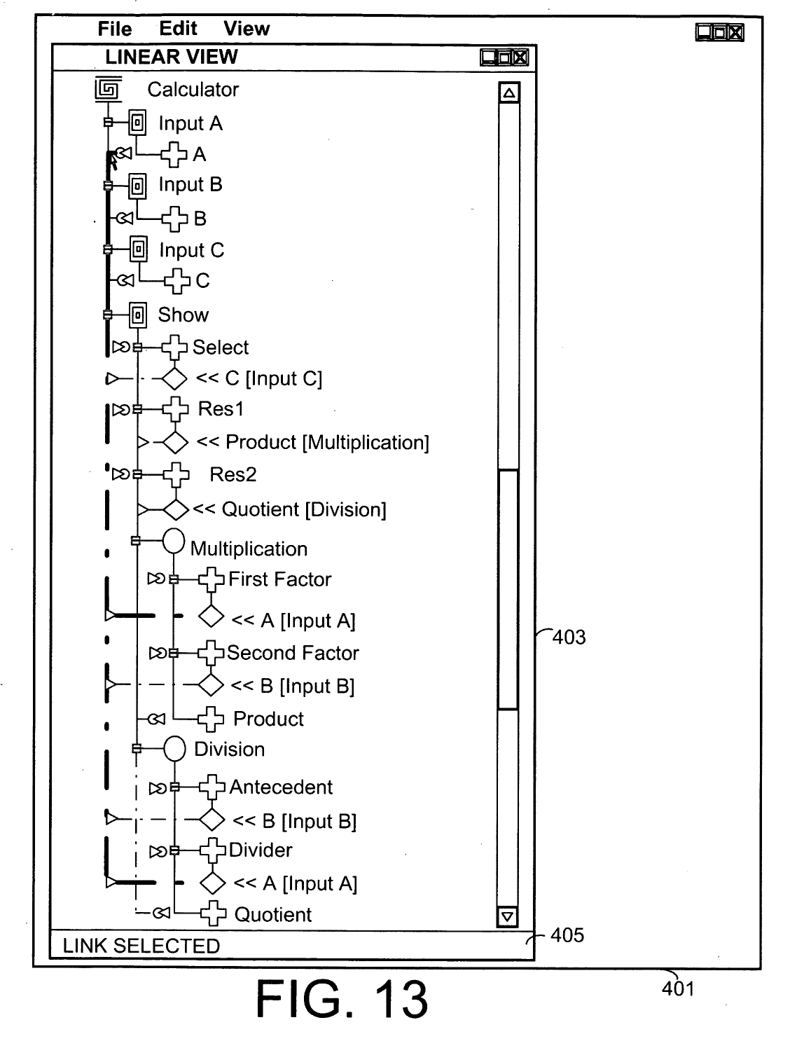

FIG. 13 illustrates the application window 401 comprising the pane 403 presenting the view of the structure, wherein a link to be removed is specified.

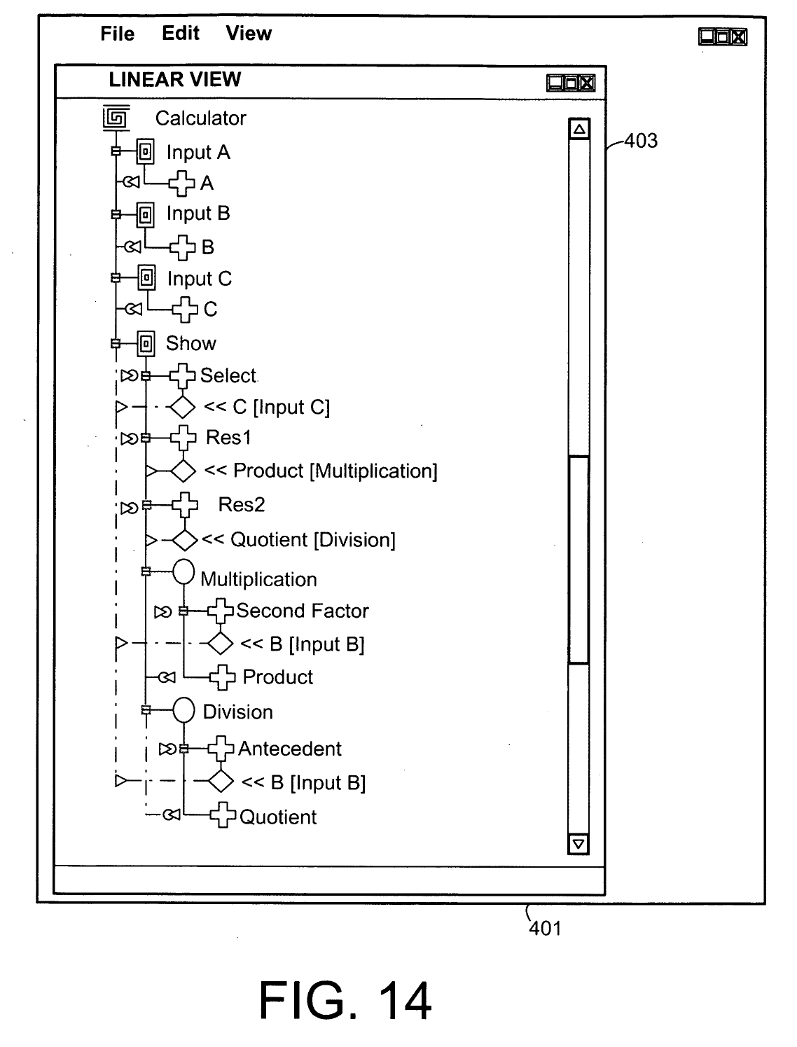

The user wishes to delete a data flow between the ports A, Select, and Divider from the structure of the program. Consequently, he moves the mouse pointer over a location of a corresponding data flow link within the pane 403, and clicks on the left button of the mouse in order to select the link, in response to which the tool tip 405 displays a message confirming the selection. Thereafter, the user clicks on a control button responsible for deleting selected elements and consequently, the link is removed along with sub-nodes associated with the ports First Factor and Divider. The resulting node-link structure is illustrated in FIG. 14, within the pane 403.

As mentioned previously, hierarchical structures expand mainly along a vertical axis, and when a program reaches a substantial length, displaying each created node may be cumbersome, especially when a user is navigating through the structure. As a result, users often require for nodes of lesser interest to be removed from the view presented by the pane 403, without being deleted. According to the present invention, a user may hide descendants of a specified node, wherein hidden nodes are removed from a view presented by the pane 403, but may be conveniently recovered according to the needs of the user.

In order to hide descendants of a node, the user moves the mouse pointer to a specified location of an expansion indicator associated to the node, and clicks on the left button of the mouse. Subsequently, all descendants of the node are removed from the view presented by the pane 403, along with their data reference points, expansion indicators, sub-nodes, data flow links, and hierarchical links through which they are related to the node.

In the preferred embodiment, if the node to be collapsed represents a port involved at the receiving end of a data flow, an end of a data flow link associated to its sub-node becomes associated to its data flow reference point. If however, the node to be collapsed represents a gate or a functional object, and its at least one child is involved a data flow, at least one triangle is displayed as adjacent to its expansion indicator, wherein the position of the triangles indicates whether its at least one child is a source, a destination, or a source and a destination of a data flow with ports of which it is not an ancestor.

The user may recover hidden descendants, sub-nodes, links, expansion indicators, and data flow reference points associated to a node by moving the mouse pointer to a location of an expansion indicator displayed within the pane 403 as associated to the node, and clicking on the left button of the mouse.

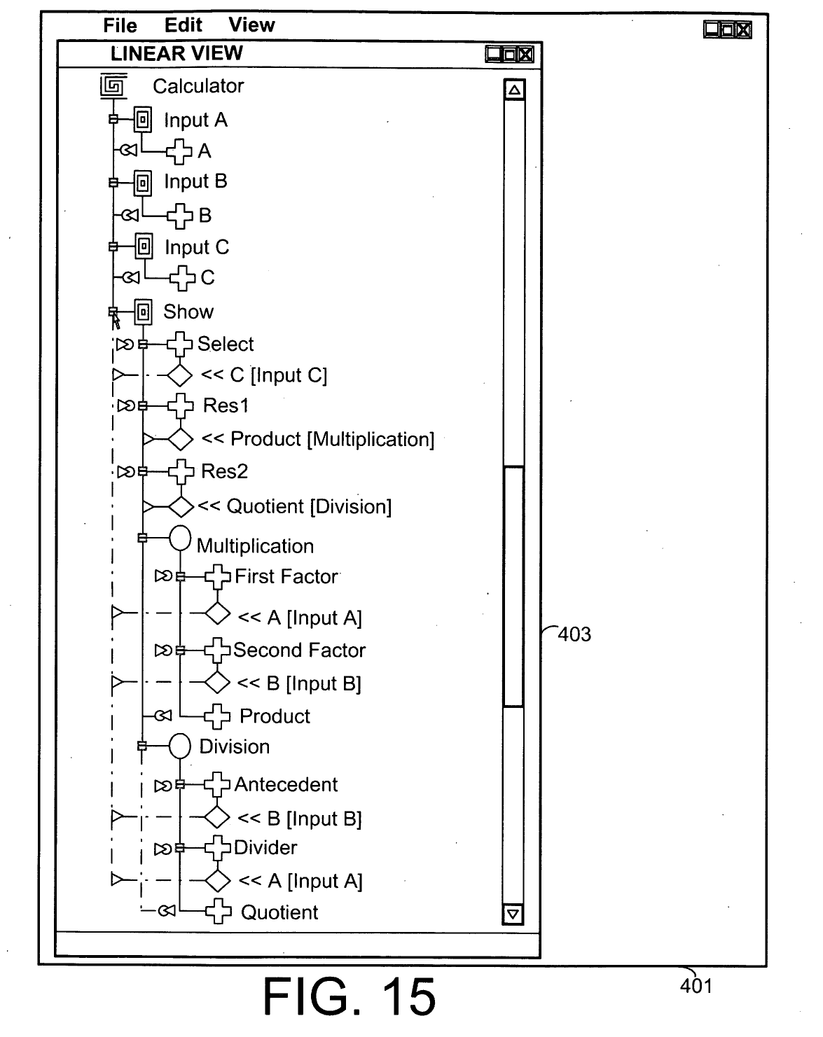

FIG. 15 illustrates the application window 401 comprising the pane 403 presenting the view of the structure, wherein a parent node to be collapsed is specified.

The user wishes to collapse the node Show, as a display of its internal structure within the pane 403 is deemed cumbersome. According to the view presented by the pane 403, the object Show has five immediate children, namely the ports Select, Res1, and Res2, as well as the functional objects Multiplication, and Division. The functional object Multiplication has three children, namely the ports First Factor, Second Factor, and Product. The functional object Division also has three children, namely the ports Antecedent, Divider, and Quotient. As a result, all descendants of the object Show are removed, as well as their data flow reference points, sub-nodes, data flow links, and hierarchical links.

The ports Res1 and Res2 are destinations of data flows originating from the ports Product and Quotient, which are descendants of the object Show. Therefore, those data flows do not need to be represented. However, the ports Select, First Factor, Second Factor, Antecedent, and Divider are destinations of data flows originating from the ports A, B, and C, which are not descendants of the object Show. As a result, a triangle 429 is displayed as adjacent to the expansion indicator of the object Show, pointing towards the node Show, as a graphical indication that at least one descendant of the object Show is involved at the receiving end of a data flow originating from an external port.

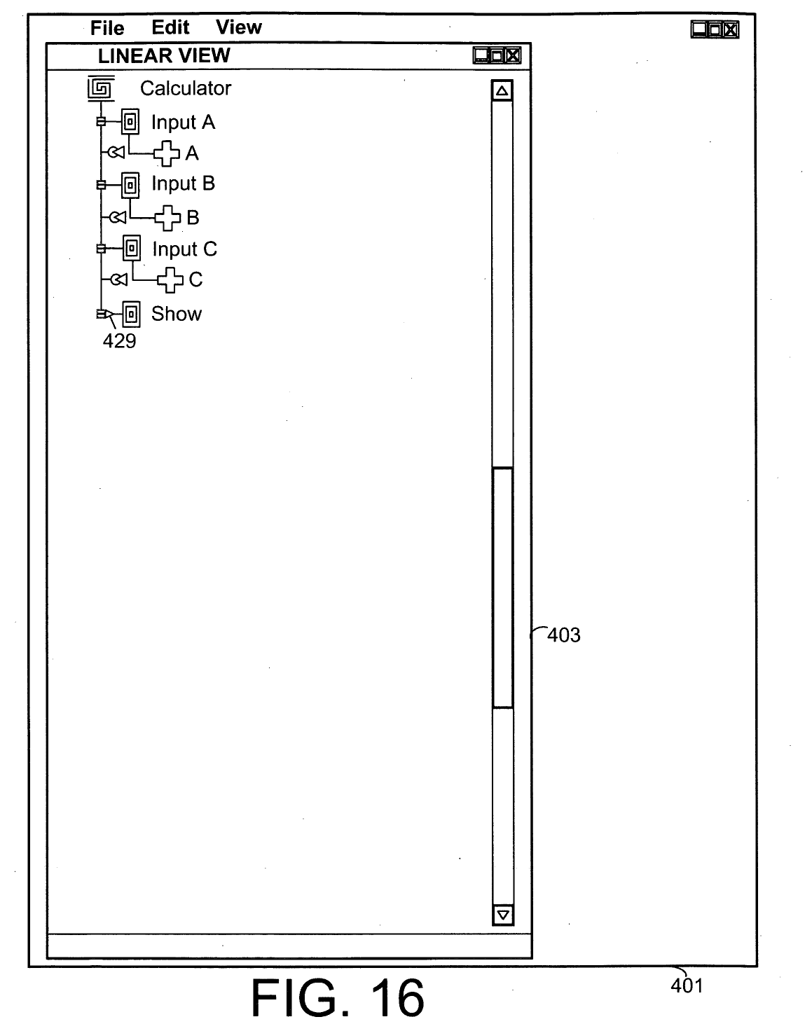

The resulting node-link structure is presented within the view presented by the pane 403, as illustrated in FIG. 16. In order to recover the structure illustrated in FIG. 15, the user would move the mouse pointer over the corresponding expansion indicator, and click on the left button of the mouse.

According to the present invention, a user may move a mouse pointer to a location of a data flow link, and wait for an amount of time indicating his interest in viewing a description of the data flow, in response to which, a tool tip is displayed specifying involved variables.

Alternatively, the user may move the mouse pointer over a location of the data flow link and click twice on the left button, in which case the view presented within the pane 403 is modified in order to display one of a corresponding destination and source that is farthest from its center. If the corresponding node is not hidden, the view is simply shifted. If however, the node is hidden, its ancestors are exploded until it is revealed, and a corresponding shift of the view is performed.

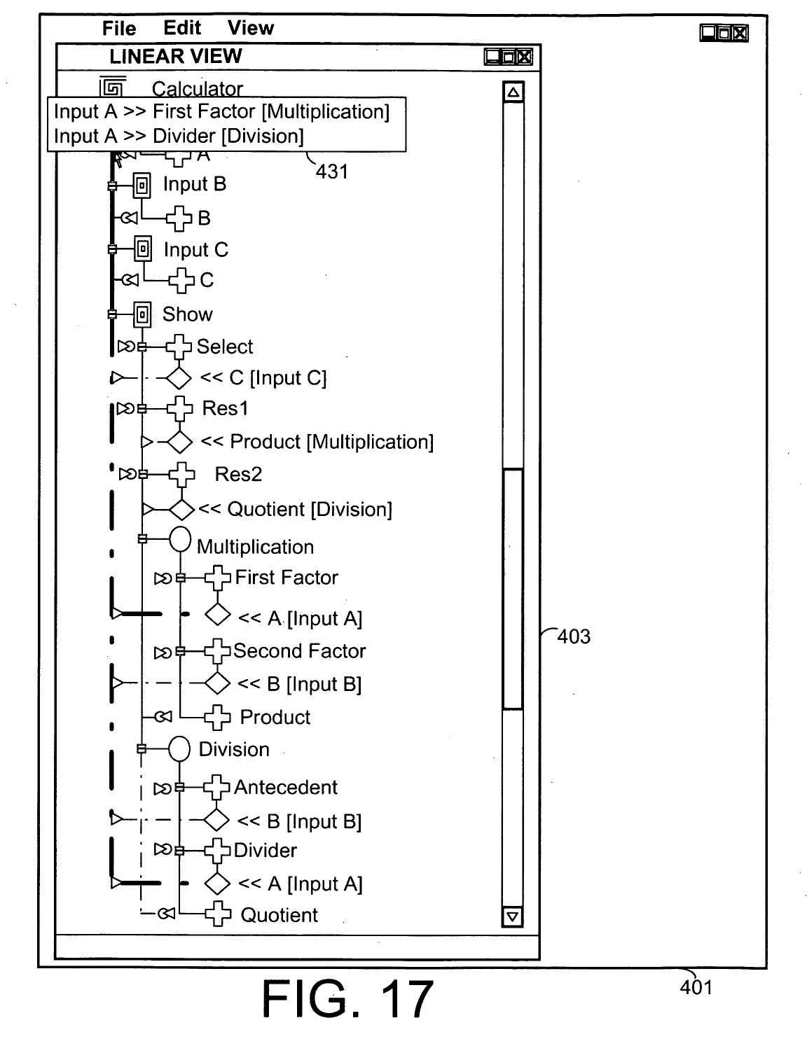

FIG. 17 illustrates the application window comprising the pane presenting the view of the structure, wherein a tool tip presenting information relating to a data flow represented by a specified link is displayed.

The user wishes to view ports involved in a data flow represented by a specific link. He therefore moves the mouse pointer over a location the link, and waits for an amount of time indicating his interest in viewing a description of the corresponding data flow, in response to which a tool tip 431 is displayed, specifying the source and two destinations of the link 443, as well as the corresponding variables.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

What is claimed is:

1. A method of generating a graphical representation of a program on a display device comprising:
providing a hierarchical ranking of programming objects;
displaying nodes representing said programming objects according to a hierarchical structure and said hierarchical ranking;
specifying at least one transmission of data between a first and a second of said programming objects;
identifying parameters of said transmission according to said at least one of said first and said second programming objects; and
displaying a link relating nodes representing said first and said second according to said parameters, wherein said link represents said at least one transmission of data.

2. The method of claim 1, wherein said specifying at least one transmission comprises identifying one of said first and said second as a source of said transmission, and the other, as a destination of said transmission, wherein said link is displayed according to said source and said destination.

3. The method of claim 2, further comprising requesting a detailed view of said destination, removing said link, displaying a sub-node of a node representing said destination, and displaying a new link relating said sub-node and a node representing said source in response to said requesting, wherein said sub-node represents said data.

4. The method of claim 3, further comprising requesting a non-detailed view of said destination, removing said link relating said sub-node, hiding said sub-node, and displaying a new link relating said node representing said source and said node representing said destination in response to said requesting.

5. The method of claims 1 or 2, further comprising displaying a label describing said transmission.

6. The method of claim 5, further comprising requesting a display of said label, wherein said label is displayed in response to said requesting.

7. The method of claim 5, wherein said label indicates said source.

8. The method of claims 1 or 2, wherein according to said hierarchical structure, a first node is displayed under, related through a hierarchical link to, and indented relatively to, a second node if a programming object represented by said first node is a child of a programming object represented by said second node.

9. The method of claim 8, wherein said identifying comprises identifying one of at least one programming object containing said source and said destination having a lowest rank, wherein a vertical section of said link relating nodes representing said first and said second according to said parameters is aligned with a vertical section of a hierarchical link relating nodes representing said one of at least one programming object and a child of said one of at least one programming object.

10. The method of claim 1, further comprising requesting a different hierarchical structure, and modifying said graphical representation of a program according to said different hierarchical structure in response to said requesting.

11. The method of claim 1, further comprising selecting a node representing an undesirable programming objects, and deleting said node representing said undesirable programming object.

12. The method of claim 1, further comprising requesting for each node representing a programming object contained in a selected parent programming object to be hidden, removing said each node representing a programming object contained in a selected parent programming object, removing said link, and providing a node representing said selected parent with a graphical indication of an involvement of a hidden programming object contained in said selected parent in said at least one transmission of data, wherein either one of said first and said second programming objects are contained in said selected parent.

13. The method of claim 12, further comprising requesting a detailed view of said parent, revealing nodes representing programming objects contained in said parent, removing said graphical indication associated with said node representing said selected parent, and displaying a link associated to nodes representing said first and said second programming objects.

14. The method of claim 1, further comprising requesting for a node of interest representing a programming object of interest to be displayed, searching through said hierarchical ranking for said programming object of interest, determining a hierarchical rank of said programming object of interest, and displaying said node of interest according to said hierarchical rank of said programming object of interest on said display device in response to said requesting.

15. The method of claim 14, further comprising revealing at least one node representing a programming object contained in another, wherein said node of interest is one of said at least one node.

16. The method of claim 14, wherein said requesting comprises selecting a link through which said node of interest is related.

17. The method of claim 2, wherein said link is displayed as a red arrow, whereby said red indicates an incoherence between a type of said source and a type of said destination.

18. A computer program product for generating a graphical representation of a program on a display device comprising a computer usable storage medium having computer readable program code means embodied in the medium, the computer readable program code means comprising:
computer readable program code means for providing a hierarchical ranking of programming objects;
computer readable program code means for displaying nodes representing said programming objects according to a hierarchical structure and said hierarchical ranking on said display device;
computer readable program code means for specifying at least one transmission of data between a first and a second of said programming objects;
computer readable program code means for identifying parameters of said transmission according to said at least one of said first and said second programming objects; and
computer readable program code means for displaying on said display device a link relating nodes representing said first and said second according to said parameters, wherein said link represents said at least one transmission of data.
